(19) United States
(12) Patent Application Publication
(10) Pub. No.: US 2011/0281136 A1
(43) Pub. Date: Nov. 17, 2011

(54) COPPER-MANGANESE BONDING STRUCTURE FOR ELECTRONIC PACKAGES

(76) Inventors: Jenq-Gong Duh, Hsinchu City (TW); Chien-Fu Tseng, Taipei City (TW)

(21) Appl. No.: 12/780,444

(22) Filed: May 14, 2010

(51) Int. Cl. B32B 15/20

(52) U.S. Cl. 428/674

(57) ABSTRACT

A copper-manganese bonding structure adopted for use on Under Bump Metallurgy (UBM) at solder joints in packaging technology includes an electronic element, at least one soldering material and at least one manganese bonding material. The electronic element has at least one copper conductive portion. The soldering material corresponds to the copper conductive portion. The manganese bonding material is arranged in the copper conductive portion and the soldering material to form bonding between them. The manganese bonding material can reduce the generation of a brittle intermetallic compound Cu₃Sn and suppress the generation of voids. The copper conductive portion is not consumed by the generation of the intermetallic compound. Thus the total structure can be protected and improved.

### FIELD OF THE INVENTION

The present invention relates to an electronic package technology and particularly to a copper-manganese bonding structure adopted for use on electronic packages.

### BACKGROUND OF THE INVENTION

Constant advances of manufacturing technology in semiconductor industry have extended the applicability of Moore's law and created a great challenge to packaging technology. The advanced manufacturing technology has to incorporate with matching packaging technology to be applicable on circuit boards, otherwise it is useless. Development of Flip Chip (F/C) provides an important link to the advanced manufacturing process. F/C mainly is applicable on a slim and thin package that requires high I/O pin counts and improved heat dissipation. F/C also can enhance transmission speed of electronic signals, thus has gradually become the mainstream of high density package.

Refer to FIG. 1 for a conventional F/C structure. It includes a chip 1 and a plurality of solder pads 2, a substrate 3 with a plurality of contacts 4 formed thereon, and a plurality of tin-based solder balls 5 to connect the solder pads 2 and contacts 4 to form binding between the chip 1 and the substrate 3. The solder pads 2 and contacts 4 are made of copper. The chip 1 forms electric connection with the substrate 3 through the solder pads 2, tin-based solder balls 5 and contacts 4. Moreover, to prevent damage by moisture and mechanical stress, a resin 6 is filled in gaps formed between the chip 1 and the substrate 3 to encase the solder pads 2, the tin-based solder balls 5 and the contacts 4.

Refer to FIGS. 2A and 2B for the electron microscopic pictures of interface reactions of the aforesaid conventional technology before and after heat treatment. After the solder pads 2 are bound to the tin-based solder balls 5, a first intermetallic layer 7 is formed between them. In this embodiment, the solder pads 2 usually are made of copper. The first intermetallic layer 7 is Cu₆Sn₅. After the package is finished, it looks like FIG. 2A. Since the chip 1 generates heat during use, after in use for a period of time, the copper coming from the solder pads 2 combines with the tin in the tin-based solder balls 5 and grows as shown in FIG. 2B. After heat treatment, the solder pads 2 grow a second intermetallic layer 8, Cu₃Sn, with voids 9 generated inside. Generation of the voids 9 greatly results from unbalance diffusion speed of copper atoms and tin atoms in the second intermetallic layer 8. As the copper atoms diffuse at a faster speed than the tin atoms, the Sn atoms cannot be replenished fast enough at the interface between the solder pads 2 and second intermetallic layer 8. Hence, accumulation of atomic vacancy at the interface creates excessive voids 9 that reduce binding strength between the solder pads 2, contacts 4 and the tin-based solder balls 5. As a result, the binding strength between the chip 1 and substrate 3 also decreases and the capability to withstand shearing force and stress deteriorates, and the reliability of the solder points also drops. This tends to cause defective connection of the chip 1 when subject to vibration or dropping.

### SUMMARY OF THE INVENTION

The primary object of the present invention is to solve the problem of the conventional technique that generates voids due to thermal energy and results in lower reliability of solder points.

To achieve the foregoing object, the present invention provides a copper-manganese bonding structure for electronic packages that is mainly adopted for use on Under Bump Metallurgy of solder joints in packaging technology. The bonding structure includes an electronic element, at least one soldering material and at least one manganese bonding material. The electronic element has at least one copper conductive portion. The soldering material corresponds to the copper conductive portion. The manganese bonding material is arranged in the copper conductive portion and the soldering material to form bonding between them.

Compared with the conventional technique, the manganese bonding material can reduce the brittle intermetallic compound of Cu₃Sn and suppress generation of voids. In another aspect, the copper conductive portion of the present invention is not consumed due to generation of the intermetallic compound, thus can protect and improve the mechanical strength between the electronic element, copper conductive portion, manganese bonding material and soldering material, and maintain integrity of electric conductivity.

The foregoing, as well as additional objects, features and advantages of the present invention will be more readily apparent from the following detailed description, which proceeds with reference to the accompanying drawings.

### BRIEF DESCRIPTION OF THE DRAWINGS

FIG. 1 is a schematic view of the structure of a conventional flip chip.

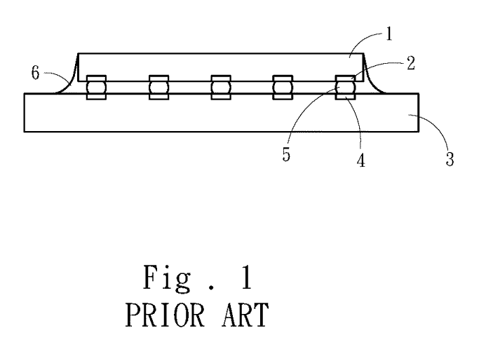

FIG. 2A is an electron microscopic picture of interface reactions of a conventional technique before heat treatment.

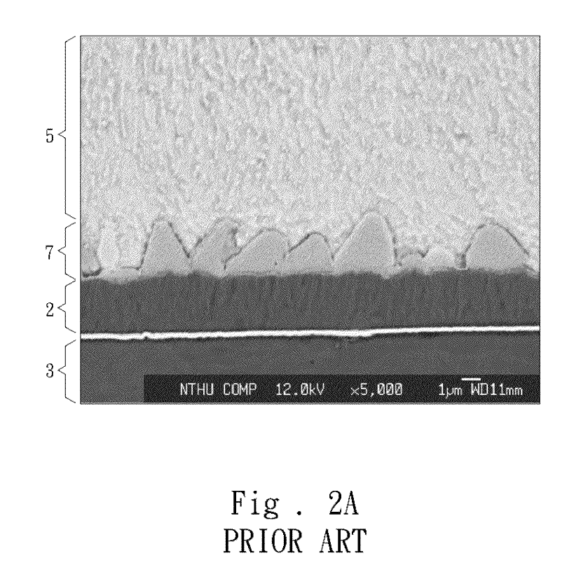

FIG. 2B is an electron microscopic picture of interface reactions of a conventional technique after heat treatment.

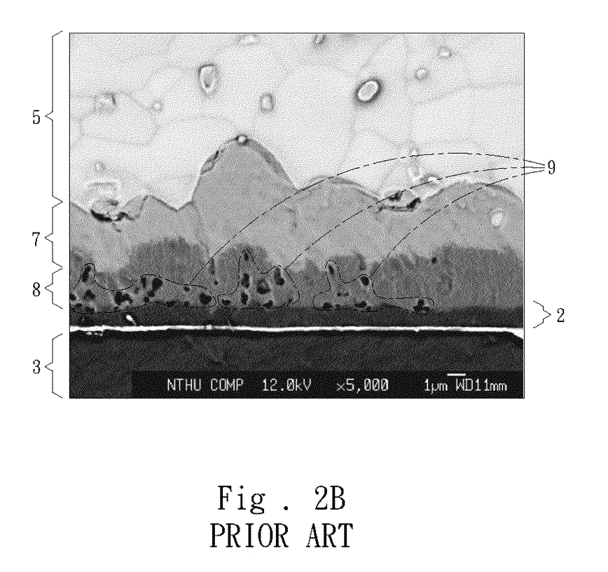

FIG. 3 is a schematic view of the structure of an embodiment of the present invention.

FIG. 4 is a schematic view of the structure of another embodiment of the present invention.

FIG. 5A is an electron microscopic picture of interface reactions of an embodiment of the present invention before heat treatment.

FIG. 5B is an electron microscopic picture of interface reactions of an embodiment of the present invention after heat treatment.

### DETAILED DESCRIPTION OF THE PREFERRED EMBODIMENTS

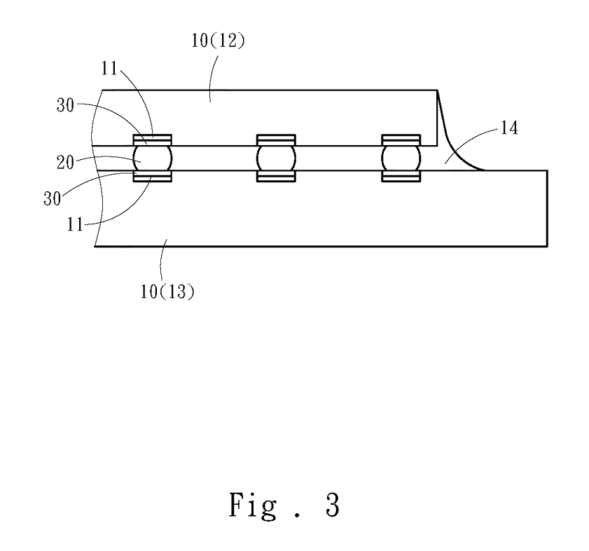

Please refer to FIG. 3 for the structure of an embodiment of the present invention. The present invention aims to provide a copper-manganese bonding structure adopted for use on electronic packages including an electronic element 10, at least one soldering material 20 and at least one manganese bonding material 30. The electronic element 10 has at least one copper conductive portion 11. The soldering material 20 corresponds to the copper conductive portion 11. The manganese bonding material 30 is arranged in the copper conductive portion 11 and the soldering material 20 to form binding between them. The manganese bonding material 30 is an alloy formed by copper and manganese in a shape of a film, a sheet, powder, struts, or alloys.

More specifically, take flip chip as an embodiment example. The electronic element 10 includes a chip 12 and a substrate 13. The chip 12 and the substrate 13 form electric connection through the copper conductive portion 11, manganese bonding material 30 and soldering material 20 via a flip chip packaging technique. The manganese bonding material 30 is manufactured selectively by electroplating, electroless plating, chemical reaction synthesizing, sputtering, rolling, fusion or powder synthesizing. In this embodiment the copper conductive portion 11 is a copper conductive line, the soldering material 20 is a tin-based soldering ball. Referring to FIG. 3, the structure, from the upper layer to the lower layer in this order, includes the chip 12, copper conductive portion 11, manganese bonding material 30, soldering material 20, manganese bonding material 30, copper conductive portion 11 and substrate 13. By means of the structure thus formed, input end and output end above the chip 12 are connected to the substrate 13. Moreover, the copper conductive portion 11 and the manganese bonding material 30 can also be made of a copper-manganese alloy. Hence in practice there is no definite boundary between them. In addition, to prevent damage by moisture and mechanical stress, a resin 14 is filled between the chip 12 and the substrate 13.

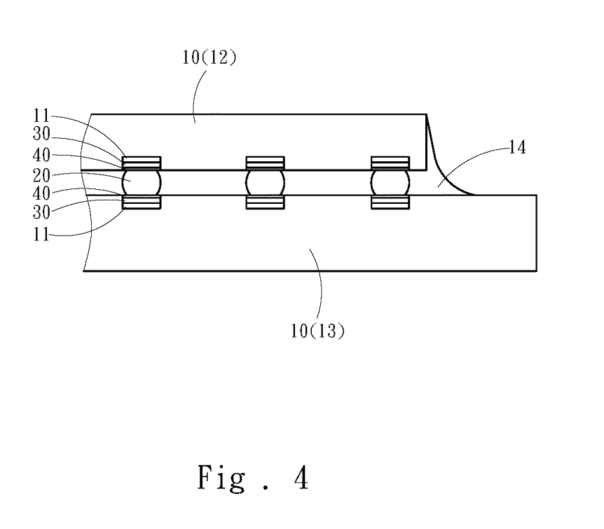

Refer to FIG. 4 for another embodiment of the present invention. In this embodiment a damp layer 40 is interposed between the manganese bonding material 30 and the soldering material 20. The damp layer 40 and the soldering material 20 are damper to retain solder paste in a ball-like fashion during soldering reflow.

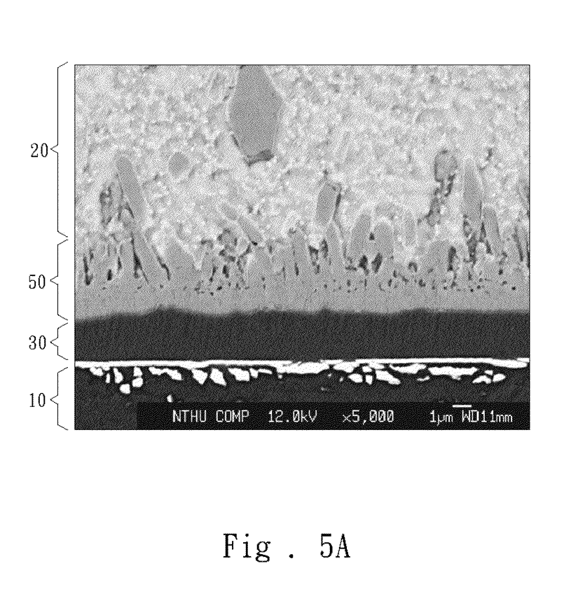

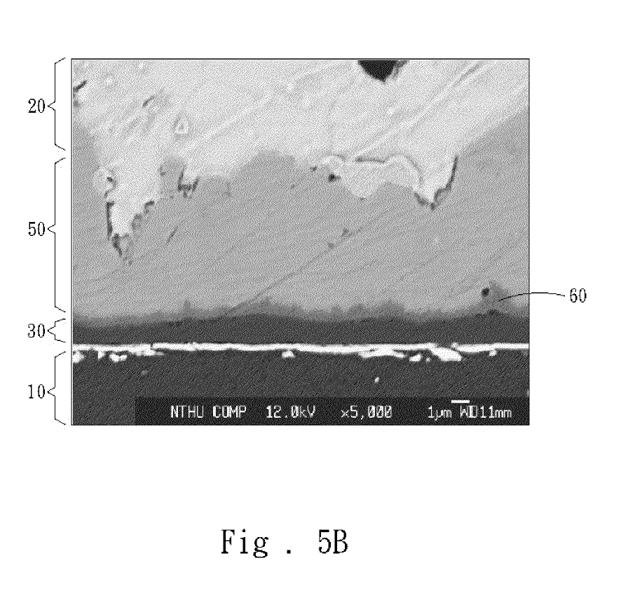

Refer to FIGS. 5A and 5B for the electron microscopic pictures of interface reactions of an embodiment of the present invention before and after heat treatment. FIG. 5B shows the result after heat treatment over twenty days at 150□ to simulate actual interface reaction between the electronic element 10 and soldering material 20 after use for a long duration under high temperature. It is to be noted that the copper conductive portion 11 and the manganese bonding material 30 are made of a copper-manganese alloy. Hence there is no obvious boundary between them in the picture, and merely the manganese bonding material 30 is marked for indication. As shown in FIG. 5A, the manganese bonding material 30 and the soldering material 20 form a intermetallic layer 50 (Cu₆Sn₅) in a needle structure which enhances the mechanical strength of the soldering material 20 and improves bonding effect thereof After reaction, referring to FIG. 5B, the manganese bonding material 30 effectively suppresses growth of a manganese-contained phase layer 60 (Cu₃Sn+Mn) to inhibit generation of voids and prevent decreasing of the reliability of the bonding structure.

As a conclusion, the present invention, by providing the manganese bonding material 30, reduces generation of the brittle manganese-contained phase layer 60 and suppresses generation of voids. Moreover, the intermetallic layer 50 forms a needle structure to enhance the bonding effect with the soldering material 20. In addition, the copper conductive layer 11 is not consumed due to generation of the intermetallic compound to protect and improve mechanical strength between the electronic element 10, copper conductive portion 11, manganese bonding material 30 and soldering material 20, and also maintain integrity of electric conductivity.

The present invention also is adaptable to other packaging technologies, such as Surface Mount Technology (SMT), wire bonding, tape automatic bonding (TAB), 3-D multi-layer chip binding and the like.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A copper-manganese bonding structure for electronic packages, comprising:
an electronic element including at least one copper conductive portion;
at least one soldering material corresponding to the copper conductive portion; and
at least one manganese bonding material bridging the copper conductive portion and the soldering material to form binding therebetween.

2. The copper-manganese bonding structure of claim 1, wherein the manganese bonding material is a copper-manganese alloy.

3. The copper-manganese bonding structure of claim 1, wherein the copper conductive portion is made of a material same as the manganese bonding material.

4. The copper-manganese bonding structure of claim 1, wherein the manganese bonding material is selectively formed is a shape of a film, a sheet, powder, struts or alloy.

5. The copper-manganese bonding structure of claim 1, wherein the fabrication method of the manganese bonding material is selected from the group consisting of electroplating, electroless plating, chemical reaction synthesizing, sputtering, rolling, fusion and powder synthesizing.

6. The copper-manganese bonding structure of claim 1, wherein the manganese bonding material and the soldering material are interposed by a damp layer.

7. The copper-manganese bonding structure of claim 1, wherein the material of the copper conductive portion is selected from the group consisting of copper and brass.

8. The copper-manganese bonding structure of claim 1, wherein the copper conductive portion is a copper conductive line.

9. The copper-manganese bonding structure of claim 1, wherein the soldering material is tin-based solder balls.
